(19) United States
(12) Patent Application Publication
(10) Pub. No.: US 2014/0307529 A1
(43) Pub. Date: Oct. 16, 2014

(54) TIMEPIECE WITH PIXEL REPRESENTATION OF MOVEMENT OF TIME

(71) Applicant: EQUITIME, INC., Newbury, MA (US)

(72) Inventors: Berj A. TERZIAN, NEWBURY, MA (US); Jack A. EKCHIAN, Belmont, MA (US); Robert Alfred BRODMANN, Weehawken, NJ (US)

(73) Assignee: EQUITIME, INC., Newbury, MA (US)

(21) Appl. No.: 13/861,925

(22) Filed: Apr. 12, 2013

(51) Int. Cl. G04G 9/00

(52) U.S. Cl. CPC G04G 9/00
USPC 368/82

(57) ABSTRACT

A timepiece having a circular dial is disclosed. At the periphery of the dial, electronic pixels sequentially appear and represent minutes. In a smaller central circle, pixels are positioned in a circular pattern and appear sequentially to represent hours. During every sixty seconds, a viewer can count the number of visible minute pixels to know the time in minutes. Similarly, the viewer can count the number of visible hour pixels to know the time in hours. These motions give a sensation of the flow of time without active numerical values.

### BACKGROUND OF INVENTION

This invention relates to timepieces and more particularly to displays of time in iconic manner.

### SUMMARY OF THE INVENTION

This invention relates to a novel timepiece which utilizes iconic elements for tracking time without active numerical values. Instead, pixels and dots are displayed as active elements which can be counted by viewers to determine current time. This system graphically displays the flow of time in incremental patterns that indicate where time is in its sequential progression.

### BRIEF DESCRIPTION OF DRAWINGS

FIG. 1 illustrates a watch face in accordance with the present invention

FIG. 2 illustrates the back of the watch case in accordance with the present invention.

FIG. 3 illustrates the watch face in accordance with the present invention at the time 2:25.

### DETAILED DESCRIPTION OF INVENTION

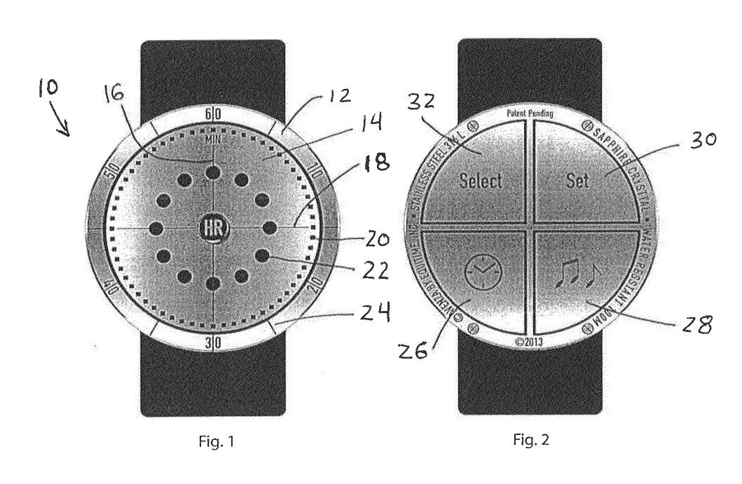

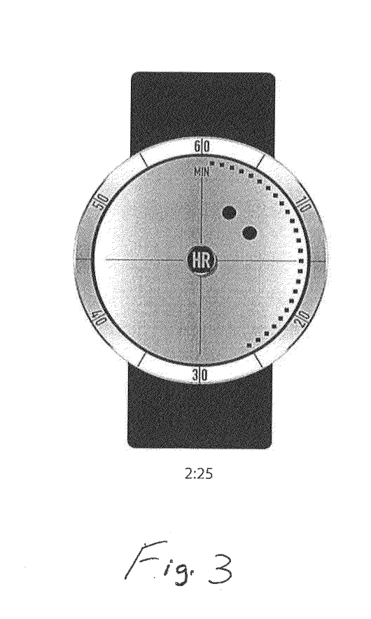

FIG. 1 displays a circular watch case 10 that includes a bezel 12 surrounding a dial 14. Vertical lines 16 and horizontal, lines 18 divide the dial into four symmetric quadrants. At the periphery of dial 14 are pixels 20 which represent minutes. Each pixel incrementally appears after sixty seconds have elapsed. Accordingly, there is enough time for the viewer to count the pixels sequentially from one to sixty and understand what the values of current minutes are. The letters, MIN, are included at the top of the dial to verify that the pixels are representative of progressive current minutes.

At the center of dial 14 are black dots 22, which are positioned in a smaller circle than the pixels 20. Dots 22 represent a total of twelve hours. After conclusion of a count of sixty minutes, each dot incrementally appears to indicate that an hour has elapsed. Twelve dots 22 indicate that a twelve hour cycle of time has elapsed, either AM or PM. The flow of pixels and dots graphically display how time progresses and this gives a sensation of iconic dynamic motion.

Bezel 12 is preferably marked with alternate hash marks 24 and stationary numerals 10, 20, 30, 40, 50 and 60 to assist viewers to count the minutes and hours as they progress sequentially larger. At the center of dial, HR characters are included in a circle to verify that the dots 22 represent progressive hours.

In 2006, applicants' assignee, Equitime, Inc, introduced a new digital watch called QUADTEC. It was operated with five push buttons marked with identifying icons, namely; a lamp emitting light beam (for lighting the display in the dark); a watch face showing 10 past 10 (for switching the display into a setting mode); a three tone musical melody (for switching the display into an alarm setting mode), and two buttons marked with SEL and SET (for selecting and setting time modes and values). Similar buttons and functions are included in drawings of the present invention, see FIG. 2 and buttons 26, 28, 30 and 32. These buttons and their operation are described in more detail in U.S. Pat. No. 7,187,624, which is incorporated herein by reference.

Manufacture of a module for the above described watch face can be readily accomplished by preparing an object code and then programming it in the ROM of a silicon LCD chip. The same technique was used in manufacturing the previous QUADTEC watch in 2006.

An embodiment of the invention has been described. All variations of the embodiment are intended to be covered within the scope of the following claims and all equivalents thereof.

1. A timepiece comprising:
(a) a circular case including a circular dial and a bezel thereon,
(b) sequential pixels appearing at the periphery of the dial as representations of current minutes, in absence of digital values of minutes; and
(c) sequential dots in a smaller circle as representations of current hours, in absence of digital values of hours, whereby time is displayed a entirely in symbolic motions of time.

2. A time piece according to claim 1, wherein vertical and horizontal lines are included to divide the dial into four symmetric quadrants.

3. A timepiece according to claim 2, where alternate hash marks and stationary numerals 10, 20, 30, 40, 50 and 60 are included on the bezel to assist counting the pixels as they sequentially appear in greater numbers.

4. A timepiece according to claim 1, wherein:
the plurality of pixels representing minutes are not visible at the beginning of a sixty minute period of time, wherein a pixel representing a minute is displayed after each elapsed minute during the sixty minute period of time; and
the plurality of pixels representing hours are not visible at the beginning of a twelve hour period of time, wherein a pixel representing an hour is displayed after each elapsed hour during the twelve hour period of time.
